(19) United States
(12) Patent Application Publication
(10) Pub. No.: US 2011/0298599 A1
(43) Pub. Date: Dec. 8, 2011

(54) Image generation apparatus

(75) Inventor: Kenichi Oonishi, Kariya-city (JP)

(73) Assignee: DENSO CORPORATION, Kariya-city (JP)

(21) Appl. No.: 13/134,353

(22) Filed: Jun. 6, 2011

(30) Foreign Application Priority Data
Jun. 8, 2010 (JP) 2010-131398

(51) Int. Cl. B60Q 1/00

(52) U.S. Cl. 340/425.5

(57) ABSTRACT

An image generation apparatus mounted to a vehicle to generate a display image to be displayed on a display device is disclosed. The apparatus is configured to: acquire a video signal of a main image that is generated by an in-vehicle apparatus as being smaller in the number of pixels than the display image; generate a complement image that compensates for a difference in the number of pixels between the display image and the main image; and combine the main image and the complement image, thereby generating the display image in which the main image and the complement image are placed side by side.

### CROSS REFERENCE TO RELATED APPLICATION

The present application is based on and claims priority to Japanese Patent Application No. 2010-131398 filed on Jun. 8, 2010, disclosure of which is incorporated herein by reference.

### BACKGROUND

1. Technical Field

The present disclosure relates to an image generation apparatus that is mounted in a vehicle, includes a display device provided to face a passenger of the vehicle and is configured to generate a display image to be displayed on the display device.

2. Description of Related Art

There is known an apparatus for displaying a display image on a display device provided to face a passenger of the vehicle. In this apparatus, multiple images may be placed side by side on the display image.

For example, JP-2008-195393A1 corresponding to US 2008/0150709A1 discloses a vehicular display apparatus. The vehicular display apparatus is connected with a navigation apparatus and various sensors etc. mounted in the vehicle, and includes a controller for generating the display image to be displayed on the display device. The controller generates the display image having a navigation image and a vehicle state image etc. placed side by side, based on information about the navigation image inputted from the navigation apparatus, detection information inputted from the sensors, and the like. The controller outputs an image signal of the generated display image to the display device, thereby displaying the display image on the display device.

JP-H6-195056A1 discloses a display apparatus including an image converter. The image converter is connected with various in-vehicle apparatuses mounted in a vehicle. The various in-vehicle apparatuses are, for example, a navigation apparatus, a character generator configured to acquire vehicle information from a system controller of the vehicle, and the like. The image converter acquires image signals of main images generated by these in-vehicle apparatuses. For example, the image converter acquires an image signal of map information, a character image signal associated with state of the vehicle, and the like. Based on the acquired image signals of multiple images, the image converter generates the display image by placing the multiple images side by side. The generated display image is outputted to a monitor and displayed on the monitor.

In recent years, the number of pixels that the display device can display is remarkably increasing because of enlargement and high definition of the display device. As the number of pixels that the display device can display is increased, a display image displayed on the display device becomes able to notify much more information to the passenger of the vehicle. Thus, there is strong demand to install a display device with a large number of pixels in the vehicle. Hereinafter, the number of pixels that the display device can display is also referred to as the number of display pixels of the display device.

The inventors of the present application have found out the following difficulties associated with the above image generation apparatuses.

To fully use display performance of the display device having a large number of display pixels, the number of pixels of the display image, which is outputted to the display device, should be increased so that the number of pixels of the display image matches the number of display pixels of the display device. For example, if the display device for the vehicular display apparatus disclosed in JP-2008-195393A1 corresponding to US 2008/0150709A1 is changed into another display device with a larger number of display pixels, the number of pixels of the display image generated by the controller should be increased so as to match the number of display pixels of the display device. In this case, a change of the display device into a display device having a large number of display pixels requires a specification change of the controller in respect to generation of the display image. If the specification of the controller is not changed, the display image displayed on the display device cannot efficiently use the number of display pixels of the display device.

If the monitor for the display apparatus disclosed in JP-H6-195056A1 is changed into another monitor having a larger number of display pixels, the number of pixels of the display image generated by the image converter should be also increased so as to match the number of display pixels of the monitor. In addition, in the case of the display apparatus disclosed in JP-H6-195056A1, the number of pixels of the image generable by the navigation apparatus etc. should be increased. Note that the image signal of the image generated by the navigation apparatus etc. is acquired by the image converter. As can be seen from the above, a change of the monitor into another monitor with a large number of display pixels may require a specification change of the in-vehicle apparatuses (e.g., the navigation apparatus) in respect to generation of the image, in addition to the specification change of the image converter in respect to generation of the display image. If the specifications are not changed, the display image displayed on the monitor cannot efficiently use the number of display pixels of the monitor.

### SUMMARY

In view of the foregoing, it is an objective of the present disclosure to provide an image generation apparatus that can fully use display performance of a display device while efficiently using a main image generated by an existing in-vehicle apparatus.

According to an aspect of the present disclosure, an image generation apparatus mounted to a vehicle and configured to generate a display image is provided. The image generation apparatus includes a display device, a video acquisition portion, a drawing portion, a combining portion, and an output portion. The display device is provided to face a passenger of the vehicle to display the display image. The video acquisition portion is configured to acquire, from an in-vehicle apparatus mounted to the vehicle, a video signal of a main image that is generated by the in-vehicle apparatus as being smaller in the number of pixels than the display image. The drawing portion is configured to generate a complement image that compensates for a difference in the number of pixels between the display image and the main image. The combining portion is configured to combine the main image, which is based on the video signal acquired by the video acquisition portion, and the complement image, which is generated by the drawing portion. Thereby, the combining portion generates the display image in which the main image and the complement image are placed side by side. The output portion is configured to output a video signal of the display image to the display device to cause the display device to display the display image.

According to the above image generation apparatus, the combining portion can generate the display image having the main image and the complement image arranged side by side, by performing image composition between the main image, which is generated by the in-vehicle apparatus mounted to the vehicle, and the complement image, which is generated by the drawing portion. In this display image, the complement image compensates for a difference in the number of pixels between the display image and the main image. Thus, when the number of pixels of the main image generated by the in-vehicle apparatus is smaller than the number of display pixels of the display device, the image generation apparatus can generate the display image having the number of pixels that matches the number of display pixels of the display device. Because this, when the display device mounted to the vehicle is changed into another one having a larger number of display pixels, the number of pixels of the main image generated by the in-vehicle apparatus needs not to be increased in response to an increase in the number of pixels of the display device. Therefore, it becomes possible to change the display device into another display device having a larger number of display pixels while minimizing a specification change of the in-vehicle apparatus in respect to generation of the main image. In this way, the image generation apparatus can fully use display performance of a display device while efficiently using a main image generated by an existing in-vehicle apparatus

### BRIEF DESCRIPTION OF THE DRAWINGS

The above and other objects, features and advantages of the present invention will become more apparent from the following detailed description made with reference to the accompanying drawings. In the drawings:

FIG. 1 is a diagram illustrating an image generation apparatus of one embodiment;

FIG. 2 is a diagram illustrating a display image generated by the image generation apparatus when a navigation image is selected as a main image and an audio image is selected as a complement image;

FIG. 3 is a diagram illustrating a display image generated by the image generation apparatus when an air conditioner information image is selected as the main image and the audio image is selected as the complement image;

FIG. 4 is a diagram illustrating a display image generated by the image generation apparatus when an audio image is selected as the main image and an air conditioner information image is selected as the complement image;

FIG. 5 is a diagram illustrating a display image generated by the image generation apparatus when a maintenance information image is selected as the main image and an air conditioner information image is selected as the complement image;

FIG. 6 is a diagram illustrating a display image generated by the image generation apparatus when a TV screen image is selected as the main image and a TV control image is selected as the complement image;

FIG. 7 is a diagram illustrating a display image generated by the image generation apparatus when a night view image is selected as the main image and the audio image is selected as the complement image;

FIG. 8 is a diagram illustrating a display image generated by the image generation apparatus when a periphery monitoring image is selected as the main image and the audio image is selected as the complement image;

FIG. 9 is a flowchart illustrating a control flow to display the display image on a LCD device; and

FIG. 10 is a diagram illustrating a modification example of the display image generated by the image generation apparatus when the navigation image is selected as the main image and the air conditioner information image is selected as the complement image.

### DETAILED DESCRIPTION OF EMBODIMENTS

Embodiments of the present invention will be described with reference to the accompanying drawings.

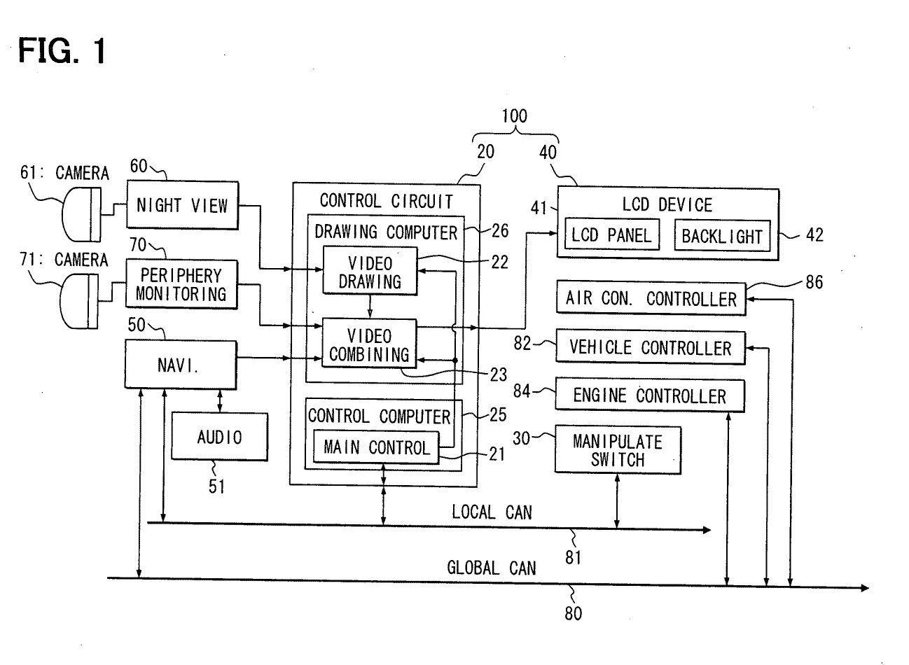

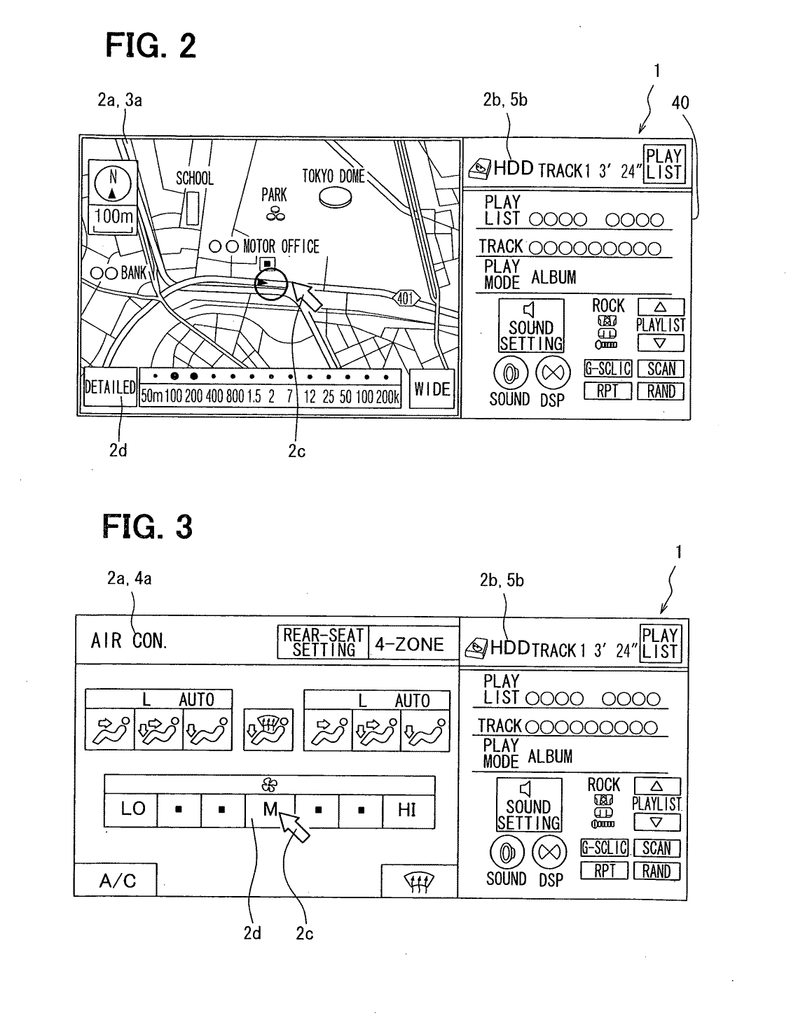

FIG. 1 is a diagram schematically illustrating a configuration of an image generation apparatus 100 of one embodiment. The image generation apparatus 100 is mounted in a vehicle and configured to generate a display image 1 (see FIG. 2 for example), which is to be displayed on a LCD (liquid crystal display) device 40. The display image 1 is an image on which a main image 2a and a complement image 2b are displayed side by side. The LCD device 40, which is placed to face a passenger of the vehicle, displays the display image 1 to provide a variety of information to the passenger who is in visual contact with the display image 1. For example, the LCD device 40 displays such display images 1 as illustrated in FIGS. 2 to 8.

With reference to FIG. 1, a global CAN (Controller Area Network) 80, a local CAN 81, a night view apparatus 60 and a periphery monitoring apparatus 70 will be described. Note that all of the above apparatuses are mounted in the vehicle.

The global CAN 80 and the local CAN 81 act as an in-vehicle network system, which uses a predetermined protocol to enable information exchange among apparatuses mounted in the vehicle. The global CAN 80 and the local CAN 81 are constructed such that various apparatuses are connected with a bus, which is formed as two communication lines. In addition to the navigation apparatus 50, various apparatus are connected to the global CAN 80. For example, a vehicle control apparatus 82 for comprehensively controlling the vehicle, a driving power source control apparatus 84 for controlling a driving power source of the vehicle such as an internal combustion engine, a motor and the like, an air conditioner control apparatus 86 for controlling air-conditioning of a vehicle compartment, and the like are connected to the global CAN 80. These apparatus 82, 84, 86 output various information to the global CAN 80. The image generation apparatus 100, the navigation apparatus 50, a manipulation switch 30 and the like are connected to the local CAN 81.

The manipulation switch 30 acts as an input device that is mainly manipulated by a driver (passenger) of the vehicle. The manipulation switch 30 includes a pointing device (not shown), a selection button (not shown) and the like. The pointing device allows the driver etc. to move position of a pointer image 2c on the display image 1 (see FIG. 2 for example). The selection button allows the driver etc. to select a button image 2d (see FIG. 2 etc.) drawn on the display image 1. In response to manipulation on the pointing device or the selection button by the driver etc., the manipulation switch 30 outputs manipulation information to the local CAN 81. The manipulation information, which is information about the manipulation and is outputted to the local CAN 81, is acquired by the navigation apparatus 50 and the image generation apparatus 100.

The navigation apparatus 50 is connected with the global CAN 80, the local CAN 81, an audio apparatus 51, the image generation apparatus 100 and the like. The navigation apparatus 50 acquires vehicle information, which is information about the vehicle and outputted to the global CAN 80 from the vehicle control apparatus 82, the driving power source control apparatus 84, the air conditioner control apparatus 86 or the like. The navigation apparatus 50 outputs the acquired vehicle information to the local CAN 81. The navigation apparatus 50 acquires the manipulation information, which is outputted from the manipulation switch 30 to the local CAN 81.

The navigation apparatus 50 includes a broadcasting receiver for receiving, for example, terrestrial digital broadcasting, a GPS (global positioning system) receiver, an electronic compass for measuring orientation (e.g., head direction of the vehicle), and the like.

The audio apparatus 51 plays back a music data, a video data and the like stored in an optical disk (e.g., CD, DVD etc.) or a storage device (e.g., a hard disk drive, a flash memory etc.). To the navigation apparatus 50, the audio apparatus 51 outputs track information or the video information, which may be associated with a presently-played-back track or video. The navigation apparatus 50 acquires the track information and the video information, and outputs the acquired track information and video information to the local CAN 81. The track information includes, for example, track name, artist name, album name, album artwork image, playback time and the like.

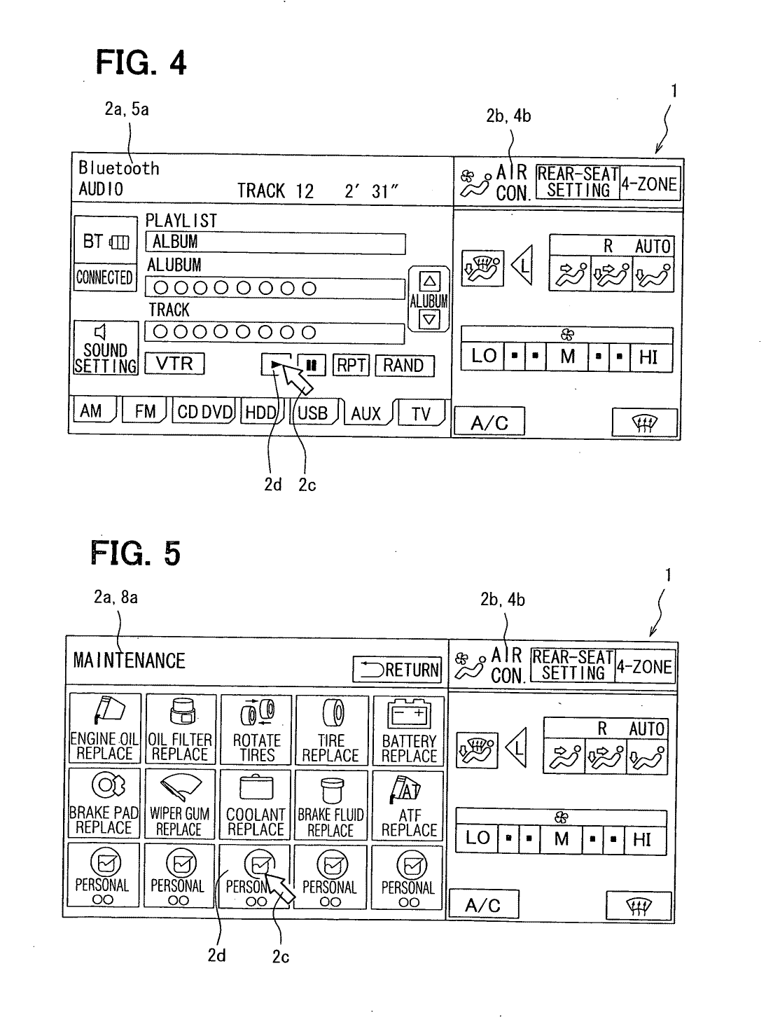

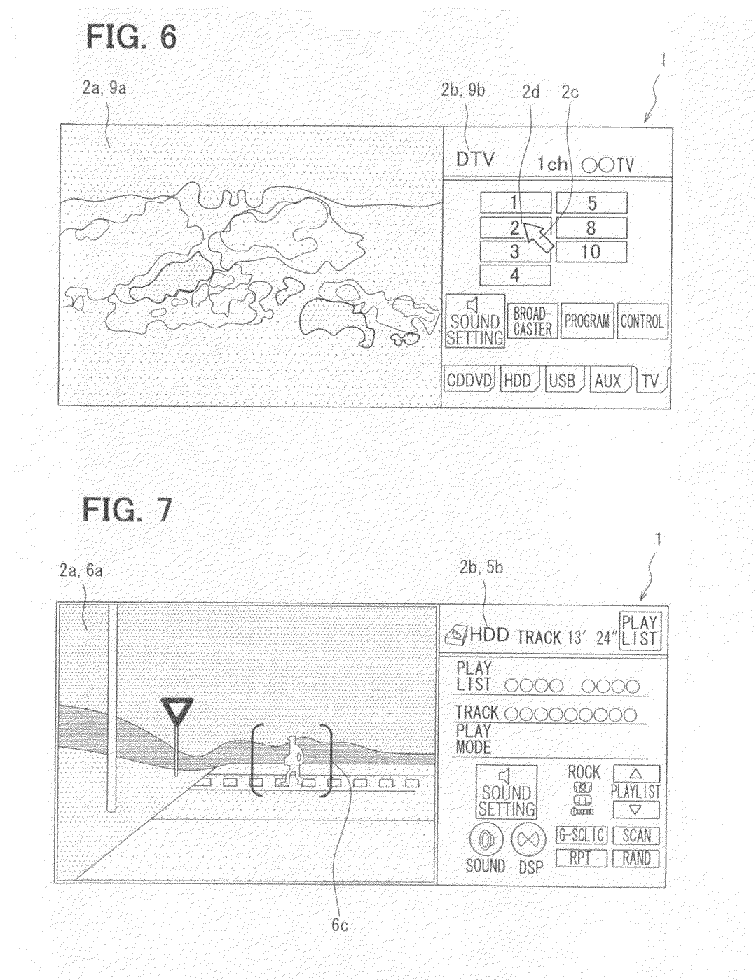

The above navigation apparatus 50 generates a navigation image 3a (see FIG. 2 for example) based on the vehicle information acquired from the global CAN 80, and position information from the GPS receiver and the electronic compass etc., so that the navigation image 3a guides a driver to a destination by assisting the driving operation of the driver. In addition, the navigation apparatus 50 generates an air conditioner information image 4a (see FIG. 3), an audio image 5a (see FIG. 4), a maintenance information image 8a (see FIG. 5), a TV screen image 9a (see FIG. 6) and the like. The TV screen image 9a is based on the terrestrial digital broadcasting received with the broadcasting receiver. Details of these images 3a, 4a, 8a and 9a will be described later.

The navigation apparatus 50 is connected with the image generation apparatus 100 via a communication line. The navigation apparatus 50 outputs an image signal of any one of the generated images 3a, 4a, 8a and 9a to the image generation apparatus 100 by a video output system such as, for example, GVIF (Gigabit Video Interface, registered trade mark) and the like.

The night view apparatus 60 is connected with a night vision camera 61. The night vision camera 61 detects, for example, infrared light to retain its imaging capability even in low-visible-light-level circumstances (e.g., night), and is provided to face in a heading direction (traveling direction) of the vehicle, so that the night vision camera 61 can image an area in front of the vehicle. The night view apparatus 60 successively acquires a video signal of the area in front of the vehicle imaged by the night vision camera 61. The night view apparatus 60 converts the video signal of the night vision camera 61, which is an analog signal, into a digital signal.

In this way, the night view apparatus 60 generates the night view image 6a (see FIG. 7) for assisting the driving operation of the driver under low-visible-light-level circumstances such as night time and the like. By an output system such as, for example, GVIF and the like, the night view apparatus 60 outputs a video signal of the generated night view image 6a to the image generation apparatus 100, which is connected with the night view apparatus 60 via the communication line.

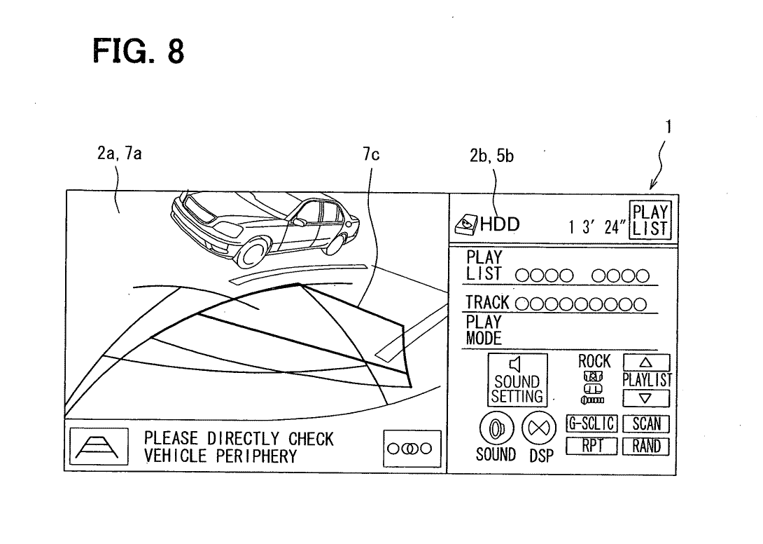

The periphery monitoring apparatus 70 is connected with a periphery monitoring camera 71, which is installed to the vehicle so as to aim and image a periphery area around the vehicle. In the present embodiment, the periphery monitoring camera 71 is installed so as to image an area in back of the vehicle. In response to an operation for instructing the periphery monitoring apparatus 70 to start, the periphery monitoring apparatus 70 causes the periphery monitoring camera 71 to start imaging the periphery area. The operation for instructing the periphery monitoring apparatus 70 to start is, for example, such a driver's operation that a shift lever (i.e., gear stick) position is changed into “R (reverse)”. The periphery monitoring apparatus 70 successively acquires a video signal of the image or the video captured by the periphery monitoring camera 71. The periphery monitoring apparatus 70 converts a video signal of the periphery monitoring camera 71, which is an analog signal, into a digital signal, which is suited for image processing. On the digitalized image, the periphery monitoring apparatus 70 superimposes a line image 7c (see FIG. 8) indicating a predicted movement path of the vehicle. In this way, the periphery monitoring apparatus 70 generates a periphery monitoring image 7a (see FIG. 8), which can assist the driving operation of the driver when the vehicle is parked. By an output system such as, for example, GVIF and the like, the periphery monitoring apparatus 70 successively outputs a video signal of the generated periphery monitoring image 7a to the image generation apparatus 100, which is connected with the periphery monitoring apparatus 70 via the communication line.

Now, a configuration of the image generation apparatus 100 will be described. The image generation apparatus 100 includes a control circuit 20 and a LCD (liquid crystal display) device 40.

The control circuit 20 is provided with a microcomputer 25 for control and another microcomputer 26 for drawing, which are also referred to herein as “control microcomputer 25” and “drawing microcomputer 26”, respectively. The control microcomputer 25 includes: a processor for performing various computation processes; a ROM (read-only memory) or a flash memory storing programs, vehicle-related information and the like used for the various computation processes; a RAM (random access memory) functioning as a working space in computation operation; and the like. The control microcomputer 25 is connected with a communication interface (not shown) that is communicatable with the local CAN 81.

The drawing microcomputer 26 includes: a processor for performing various computation processes; a ROM or a flash memory storing programs, various image data and the like used for the various computation processes; a RAM functioning as a working space in computation operation; and the like. The drawing microcomputer 26 is connected with a video output interface (not shown) that outputs the video signal of the display image 1 to the LCD device 40.

The control circuit 20 having the above configuration includes a main control portion 21, a video drawing portion 22 and a video combining portion 23.

The main control portion 21 is a functional block of the control microcomputer 25. By executing a predetermined program, the control microcomputer 25 performs a function of the main control portion 21. The main control portion 21 determines the type of image to be displayed as the main image 2a in the display image 1 and determines the type of image to be displayed as the complement image 2b in the display image 1, based on the manipulation information and the vehicle information outputted to the local CAN 81. Then, the main control portion 21 instructs the video drawing portion 22 and the video combining portion 23 to generate the display image 1. In addition, to the video drawing portion 22, the main control portion 21 gives instructions as to display position of the pointer image 2c (see FIG. 2) on the display image 1, i.e., instructions as to where the pointer image 2c (see FIG. 2) is displayed on the display image 1.

Both of the video drawing portion 22 and the video combining portion 23 are functional blocks of the drawing microcomputer 26. By executing a predetermined program, the drawing microcomputer 26 performs a function of each of the video drawing portion 22 and the video combining portion 23. The video drawing portion 22 acquires the video signal of the night view image 6a from the night view apparatus 60, which generates the night view image 6a as an image having the number of pixels smaller than the number of display pixels of the display image 1. The video drawing portion 22 analyzes whether or not a pedestrian etc. is imaged on the night view image 6a. When the pedestrian etc. is imaged on the night view image 6a, the video drawing portion 22 superimposes a frame image 6c on the night view image 6a in the vicinity of the pedestrian etc. to highlight the pedestrian etc. The night view image 6a, to which the frame image 6c may be added, is outputted to the video combining portion 23.

The video combining portion 23 can acquire the video signal of the navigation image 3a and the video signal of the periphery monitoring image 7a from the navigation apparatus 50 and the periphery monitoring apparatus 70. In addition, the video combining portion 23 can acquire the image signal of the night view image 6a from the video drawing portion 22. The video combining portion 23 selects an acquisition target video signal from among the above video signals, based on the instructions from the main control portion 21. Further, the video combining portion 23 acquires, as the main image 2a, one of the navigation image 3a, the air conditioner information image 4a, the audio image 5a, the night view image 6a, the periphery monitoring image 7a, the maintenance information image 8a and the TV screen image 9a.

The main image 2a acquired by the video combining portion 23 is generated as an image smaller in the number of pixels than the display image 1. Because of this, the video drawing portion 22 generates the complement image 2b compensating for a difference in the number of pixels between the main image 2a acquired by the video combining portion 23 and the display image 1. The complement image 2b is drawn based on the vehicle information, the track information, the manipulation information and the like, which are acquired via the local CAN 81. An image generated as the complement image 2b is, for example, an audio image 5b (see FIGS. 2 and 3), an air conditioner information image 4b (see FIGS. 4 and 5), and a TV control image 9b (see FIG. 6). The complement image 2b is outputted to the video combining portion 23.

The video combining portion 23 combines the main image 2a, which is based on the video signal acquired from an outside of the image generation apparatus 100, and the complement image 2b, which is drawn by the video drawing portion 22. Thereby, the video combining portion 23 generates the display image 1 in which the main image 2a and the complement image 2b are placed side by side. Then, the video signal of the display image 1 is successively outputted from the control circuit 20 to the LCD device 40 by a video output system such as, for example, LVDS (Low Voltage Differential Signaling) and the like. In the above-described way, the control circuit 20 displays the display image 1 on the LCD device 40.

The LCD device 40 is placed at a center portion of an instrument panel in a vehicle compartment, and displays the display image 1 to provide a variety of information to the driver. The LCD device 40 includes a LCD panel 41 and a backlight 42. The LCD panel 41 has 1280 display pixels in each horizontal row and 480 display pixels in each vertical row, and has the number of display pixels of 1280 dots×480 dots. The backlight 42 illuminates the LCD panel 41 from a backside of the LCD panel, which is opposite to a display side, in a transmissive manner. The LCD device 40 acquires the video signal from the control circuit 20 and controls each display pixel of the LCD panel 41, thereby displaying the display image 1 based on the video signal.

Multiple examples of the display image 1 displayed on the LCD device 40 are illustrated in FIGS. 2 to 8. With reference to FIGS. 2 to 8, the display image 1 will be more specifically explained.

First, the number of pixels of the display image 1, that of the main image 2a, and that of the complement image 2b will be explained. The number of pixels of the display image 1 corresponds to the number of display pixels of the LCD device 40 and is 1280 (dots)×480 (dots). The navigation image 3a, the night view image 6a and the periphery monitoring image 7a etc., each of which is used as the main image 2a, are smaller in the number of pixels than the display image 1. The number of pixels of the main image 2a is 800 (dots)×480 (dots). The navigation apparatus 50, the night view apparatus 60 and the periphery monitoring apparatus 70 can generate only the image having the number of number smaller than the number of display pixels of the LCD device 40. Thus, by combining the main image 2a and the complement image 2b, a difference in the number of pixels between the display image 1 and the main image 2a is compensated. The number of pixels of the complement image 2b is 480 (dots)×480 (dots).

The navigation image 3a, which serves as the main image 2a in FIG. 2, includes a map image indicting the present position of the vehicle. The map image is a main component of the navigation image 3a. The navigation image 3a can notify the driver of a variety of information such as the present position and the heading direction of the vehicle, a time required to arrive at the destination, and the like. The pointer image 2c and button images 2d are drawn on the navigation image 3a. The driver can place the pointer image 2c over the button image 2d by manipulating the pointing device, and can press down the selection button of the manipulation switch 30 to scale up or scale down the map image drawn on the navigation image 3a.

The audio image 5b, which servers as the complement image 2b in FIG. 2, is generated by the image generation apparatus 100 based on the track information acquired via the local CAN 81. This audio image 5b can notify the driver of the tile of the track, the album name and the like of music that is presently played back by the audio apparatus 51.

The air conditioner information image 4a, which serves as the main image 2a in FIG. 3, is generated by the navigation apparatus 50 based on the vehicle information outputted from the air conditioner control apparatus 86 to the global CAN 80. The air conditioner information image 4a can notify the driver of information about present setting of the air conditioner, e.g., information about air volume, wind direction, preset temperature and the like. The pointer image 2c and the button image 2d are drawn on the air conditioner information image 4a. The driver can place the pointer image 2c over the button image 2d by manipulating the pointing device, and can press down the selection button of the manipulation switch 30 to change the preset temperature etc. of the air conditioner. The audio image 5b acting as the complement image 2b in FIG. 3 is the same one as the complement image 2b in FIG. 2, which has been already explained.

The audio image 5a, which serves as the main image 2a in FIG. 4, is generated by the navigation apparatus 50 based on the track information acquired from the audio apparatus 51. The audio image 5a serving as the main image 2a in FIG. 4 can notify the driver of the substantially same information as the audio image 5a serving as the complement image 2b (see FIGS. 2 and 3). The track name, the album name and the like of much presently played back by the audio apparatus 51 are displayed on the audio image 5a. The pointer image 2c and the button image 2d are drawn on the audio image 5a. The driver can place the pointer image 2c over the button image 2d by manipulating the pointing device, and can press down the selection button of the manipulation switch 30 to stop the playback of the track, change the track to be played back, and the like.

The air conditioner information image 4b, which serves as the complement image 2b in FIG. 4, is generated by the video drawing portion 22 based on the vehicle information acquired from the air conditioner control apparatus 86 via the global CAN 80 and the local CAN 81. This air conditioner information image 4b can notify the driver of the substantially same information as the air conditioner information image 4b acting as the main image 2a (cf. FIG. 3). The information about present setting of the air conditioner, e.g., the information about air volume, wind direction, preset temperature and the like, is displayed on the air conditioner information image 4b.

The maintenance information image 8a, which serves as the main image 2a in FIG. 5, is generated by the navigation apparatus 50 based on the vehicle information acquired via the global CAN 80. Multiple button images 2d are displayed on the maintenance information image 8a. When the selection button of the manipulation switch 30 is pressed down with the pointer image 2c being placed over selected button image 2d, the navigation apparatus 50 acquires the vehicle information corresponding to the selected button image 2d from the vehicle control apparatus 82 and the driving power source control apparatus 84, and generates an image indicating the acquired vehicle information. The air conditioner information image 4b acting as the complement image 2b in FIG. 5 is the same one as the complement image 2b in FIG. 5, which has been already explained.

The TV screen image 9a, which serves as the main image 2a in FIG. 6, is generated by the navigation apparatus 50. The complement image 2b placed next to the TV screen image 9a is a TV control image 9b for allowing control of the TV screen image 9a. The TV control image 9b is generated by the video drawing portion 22 based on reception information acquired from the navigation apparatus 50. In addition to name of a broadcaster providing the TV broadcasting displayed on the TV screen image 9a, the multiple button images 2d for changing a reception target broadcaster are displayed on the TV control image 9b. The driver can place the pointer image 2c over one button image 2d by manipulating the pointing device, and can press down the selection button of the manipulation switch 30 to switch the TV screen image 9a into the broadcaster that corresponds to the selected one button image 2d.

The night view image 6a, which servers as the main image 2a in FIG. 7, is generated by the night view apparatus 60. The frame image 6c for drawing the driver's attention to the presence of the pedestrian etc. is superimposed on the night view image 6a. The audio image 5b serving as the complement image 2b in FIG. 7 is the same one as the complement image 2b in FIG. 2, which has been already explained.

The periphery monitoring image 7a, which serves as the main image 2a in FIG. 8, is generated by the periphery monitoring apparatus 70. The periphery monitoring image 7a is generated such that the line image 7c is superimposed on the image of the periphery area in back of the vehicle captured by the periphery monitoring camera 71. The line image 7c indicates a predicted movement path (locus) of the vehicle to assist a vehicle parking operation. The audio image 5b serving as the complement image 2b in FIG. 8 is the same one as the complement image 2b in FIG. 2, which has been already explained.

It should be noted that combinations of the main image 2a and the complement image 2b are not limited to those explicitly shown in FIGS. 2 to 8. Other combinations are possible if it does not cause confliction. In FIGS. 2 to 8, the main image 2a is arranged on a left side portion of the display image 1 in the horizontal direction and the complement image 2b is arranged on a right side portion of the display image 1 in the horizontal direction. However, the positions of the main image 2a and the complement image 2b may be interchanged according to the driver's manipulation or may be automatically interchanged.

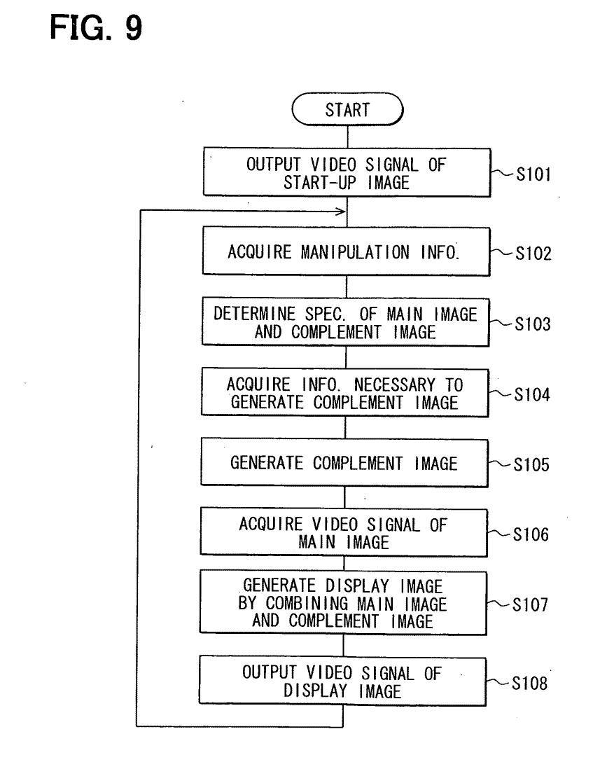

Next, with reference to FIG. 9, explanation will be given on a process performed by the image generation apparatus 100. This process is performed to acquire the vehicle information, the track information, the manipulation information and the like, acquire the image signal, and display the display image 1 on the LCD device 40. When the driver of the vehicle turns on an ACC (accessory) power, the main control portion 21 of the image generation apparatus 100 performs the process illustrated in FIG. 9.

At S101, the main control portion 21 instructs the video drawing portion 22 to generate a startup image, which is an image to be displayed at the time of startup. The video drawing portion 22 instructed by the main control portion 21 reads out a pre-stored data, and generates the startup image. A video signal of this startup image is outputted from the video drawing portion 22 to the LCD device 40; thereby, the startup image is displayed on the LCD device 40. The startup image may include, as its main component, a mark indicating a vehicle brand for example.

At S102, the main control portion 21 acquires the manipulation information via the local CAN 81. The manipulation-information indicates the driver's manipulation on the manipulation switch 30, the gear stick or the like

At S103, the main control portion 21 determines the specifications of the main image 2a and the complement image 2b based on the manipulation information acquired at S102, and the process proceeds to S104. The specifications of the main image 2a and the complement image 2b include, for example, the types of images to be displayed as the main image 2a and the complement image 2b, display positions of the main image 2a and the complement image 2b, and the like.

At S104, via the local CAN 81, the main control portion 21 acquires information needed to generate the complement image 2b that is determined at S103 to be a display target. The information is, for example, the vehicle information, the track information, the manipulation information, and the like. The acquired information needed to generate the complement image 2b is transmitted to the video drawing portion 22, and the process proceeds to S105.

At S105, the main control portion 21 causes the video drawing portion 22 to generate the complement image 2b for providing the vehicle information, the track information or the like to the driver. The complement image 2b generated by the video drawing portion 22 is successively outputted to the video combining portion 23.

At S106, the main control portion 21 instructs the video drawing portion 22 or the video combining portion 23 to acquire the video signal. When it is determined at S103 that the night view image 6a is to be displayed as the main image 2a, the main control portion 21 instructs the video drawing portion 22 to acquire the image signal of the night view image, which is outputted from the night view apparatus 60. In this case, after the video drawing portion 22 performs a process of superimposing the frame image 6c on the night view image 6a, the video combining portion 23 acquires the night view image 6a. When it is determined at S103 that the navigation image 3a or the periphery monitoring image 7a etc. is to be displayed as the main image 2a, the main control portion 21 instructs the video combining portion 23 to acquire the video signal that is outputted from the navigation apparatus 50 or the periphery monitoring apparatus 70.

At S107, the main control portion 21 instructs the video combining portion 23 to generate the display image 1. On the basis of instructions from the main control portion 21, the video combining portion 23 combines the main image 2a, which is based on the video signal acquired at S106, and the complement image 2b, which is generated at S105. Thereby, the video combining portion 23 generates the display image in which the main image 2a and the complement image 2b are placed side by side.

At S108, the main control portion 21 causes the video combining portion 23 to output the video signal of the display image 1 generated at S107 to the LCD device 40. Through the above manners, the display image 1 is displayed on the LCD device 40. After finishing S108, the process returns to S102, and S102 to S108 are repeated by the time when the ACC power of the vehicle is tuned off.

According to the present embodiment, the display image 1 is complemented such that the complement image 2b generated by the video drawing portion 22 compensates for a difference in the number of pixels between the display image 1 and the main image 2a. Therefore, even when the number of pixels of the main image 2a generated by the in-vehicle apparatus such as the navigation apparatus 50 and the like is smaller than the number of display pixels of the LCD device 40, the image generation apparatus 100 can generate the display image 1 having the number of pixels that corresponds to the number of display pixels of the LCD device 40. Because of this, even if the LCD device 40 installed in the vehicle is changed into another LCD device 40 having a larger number of display pixels, it is unnecessary to increase the number of pixels of the main image 2a in response to the larger number of pixels of the another LCD device 40. Thus, according to the present embodiment, it is possible to change the LCD device 40 into another one with a larger number of pixels while minimizing a specification change of the navigation apparatus 50, the night view apparatus 60, the periphery monitoring apparatus 70 and the like in respect to the generation of the main image 2a.

Furthermore, the display image 1, in which the main image 2a and the complement image 2b are placed side by side, can notify the driver etc. of the information appearing on the main image 2a together with the information appearing on the complement image 2b. Therefore, the display image 1 can efficiently use the number of display pixels of the LCD device 40.

In this way, the image generation apparatus 100 can use the display performance of the LCD device 40 while efficiently using the main image 2a generated by an existing navigation apparatus 50 etc. mounted in the vehicle.

Furthermore, according to the present embodiment, the image generation apparatus 100 acquires the video signal of the navigation image 3a as the main image 2a from the navigation apparatus 50. In typical, the navigation apparatus 50 generates the navigation image 3a through remarkably-complicated processes. For example, the navigation image 3a is generated through superimposition of multiple layers on which the map image, the button image 2d, the pointer image 2c and the like are drawn. Accordingly, it is likely that a slight specification change requires a huge amount of work for the specification change.

Because of this, when the image generation apparatus 100 makes it possible to use the navigation image 3a generated by the existing navigation apparatus 50, the amount of work for the specification change caused by an increase in the number of display pixels of the LCD device can be remarkably reduced. Therefore, the image generation apparatus 100 for generating the display image 1 including the navigation image 3a as the main image 2a is suited to efficiently use, while using an existing configuration, the display performance of the LCD device 40 having the increased number of display pixels.

In typical, when the number of pixels of the display image 1 is increased, the driver tends to have a difficulty of finding out high priority information in the display image 1. Therefore, one may consider that the main image 2a becomes degraded in respect to viewability of the main image 2a for the driver. However, according to the present embodiment, the display image 1 is displayed on the LCD device 40 in such manner that the complement image 2b is smaller in the number of pixels than the main image 2a. Accordingly, in the display image 1 displayed on the LCD device 40, a display area of the main image 2a can be larger than that of the complement image 2b. Therefore, in the display image 1, the main image 2a can attract the driver's eyes more than the complement image 2b. Because the main image 2a attracts the eyes of driver, it is possible to maintain high viewability of the main image 2a even when the main image 2a is generated by the existing navigation apparatus 50 etc., and placed next to the complement image 2b in the display image 1. As can be seen from the above, by keeping the number of pixels of the complement image 2b smaller than that of main image 2a, it is possible to efficiently use the main image 2a generated by the existing navigation apparatus 50 etc.

Furthermore, according to the present embodiment, since the main image 2a and the complement image 2b can notify the passenger of different information, it is possible to easily increase the information that the display image 1 provides to the driver. In this way, the image generation apparatus 100 can efficiently use the display performance of the display device 40 with the increased number of display pixels by generating the display image 1, in which the complement image 2b notifies the information different than the main image 2a notifies.

Furthermore, it may be preferable that the navigation image 3a for assisting the driver's operation is kept displayed on the LCD device 40 when the driver is operating the vehicle. In the present embodiment, since the main image 2a and the complement image 2b are placed side by side in the display image 1, the information needed to be temporarily notified to the driver can be displayed on the complement image 2b. Thus, it is possible to continue to display the navigation image 3a as the main image 2a in the display image 1. Since continuous display of the navigation image 3a is possible, the driver can continuously receive his-or-her-operation-related assistance. Therefore, the image generation apparatus 100, which can generate the display image 1 having the navigation image 3a as the main image 2a, can efficiently use display performance of the LCD device having the increased number of display pixels.

In the present embodiment, the video drawing portion 22 can correspond to a drawing means or a drawing portion. The video combining portion 23 can correspond to a combining means or a combining portion. The control circuit 20 can correspond to a video acquisition means or a video acquisition portion. The control circuit 20 can correspond to an output means or an output portion. The LCD device 40 can correspond to a display device. Each of the navigation apparatus 50, the night view apparatus 60 and the periphery monitoring apparatus 70 can correspond to an in-vehicle apparatus.

### Other Embodiments

Embodiments of the present invention are not limited to the above-described embodiment. Examples of other embodiments and modifications will be described.

In the above embodiment, the navigation image, the air conditioner information image, and the night view image etc. are described as examples of the main image 2a and the complement image 2b. However, a variety of images for notifying the passenger of information can be used as the main image 2a and the complement image 2b. For example, if the vehicle is equipped with sonar for detecting an obstacle around the vehicle, the image generation apparatus may use a sonar image as the main image 2a or the complement image 2b of the display image 1. The sonar imager notifies the driver of information about a detection result of the sonar. Alternatively, for example, when the audio apparatus 51 plays back a video data stored in a DVD, an image for the passenger to control the playback of the video data may be displayed as the complement image 2b. Alternatively, if an external device such as a portable music player, a cellular phone and the like is connected to the audio apparatus 51, an image for the passenger to control the external device via the manipulation switch 30 may be displayed as the main image 2a or the complement image 2b on the LCD panel 41. Alternatively, the image generation apparatus may calculates fuel efficiency of the vehicle based on the vehicle information outputted from the vehicle control apparatus 82 and the driving power source control apparatus 84, and may notify the driver of information about the fuel efficiency via the main image 2a or the complement image 2b.

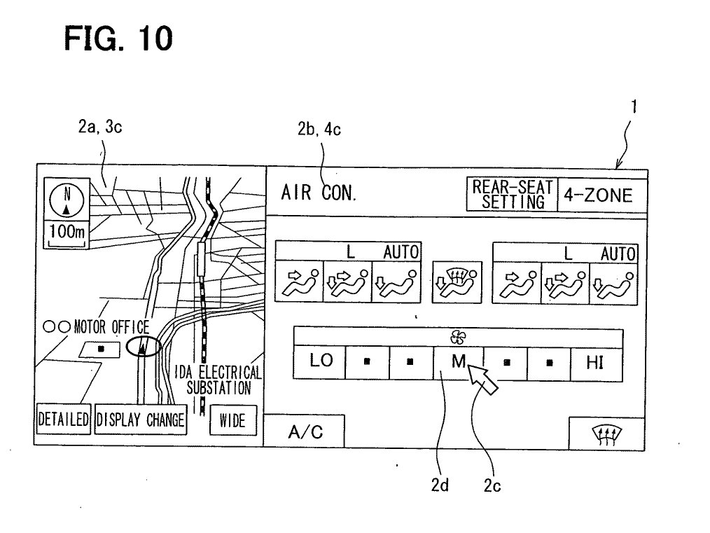

In the above embodiments, the number of pixels of the main image 2a is larger than that of the complement image 2b. Alternatively, as shown in FIG. 10, the number of pixels of the main image 2a may be smaller than that of the complement image 2b. In this case, the number of pixels of the main image 2a may be, for example, 480 (dots)×480 (dots), and the number of pixels of the complement image 2b may be, for example, 800 (dots)×480 (dots). To generate the display image 1 illustrated in FIG. 10, the video drawing portion 22 may generate, for example, an air conditioner information image 4c with 800 (dots)×480 (dots) as the complement image 2b. Then, a navigation image 3c with 480 (dots)×480 (dots) as the main image 2a is generated in such manner that the video combining portion 23 performs trimming on the navigation image 3a, which is based on the video signal from the navigation apparatus 50, to remove outer parts of the navigation image 3a in the horizontal direction. Then, the video combining portion 23 combines the navigation image 3c and the air conditioner information image 4b, thereby generating the display image 1.

In the above embodiment, the control circuit 20 includes the main control portion 21, the video drawing portion 22 and the video combining portion 23, which are provided as functional blocks of two microcomputers. Specifically, the main control portion 21 is a functional block of the control microcomputer 25. The video drawing portion 22 and the video combining portion 23 are functional blocks of the drawing microcomputer 26. However, a configuration of the control circuit 20 is not limited to that described in the above embodiment. For example, the main control portion 21, the video drawing portion 22 and the video combining portion 23 may be functional blocks of a single microcomputer mounted to the control circuit 20. Alternatively, the control circuit 20 may include an analog circuit that is configured to function as the main control portion 21, the video drawing portion 22 and the video combining portion 23 without executing a program.

In the above embodiment, after the vehicle information outputted to the global CAN 80 is acquired by the navigation apparatus 50, the vehicle information is outputted from the navigation apparatus 50 to the local CAN 81, and then acquired by the image generation apparatus 100. Alternatively, the image generation apparatus 100 may be directly connected with the global CAN 80, and may acquire the vehicle information not via the local CAN 81 but via the global CAN 80.

In the above embodiment, the manipulation switch 30 includes an input device with a pointing device and a selection button for allowing a user (e.g., the driver) to control position of the pointer image 2c and select a function. For example, the pointing device may include: a joystick, which moves the pointer image 2c in response to a pivot manipulation on a lever; a touch pad, which moves the pointer image 2c in response to a touch manipulation on a planer sensor; a dial mechanism, which moves the pointer image 2c in response to rotation manipulation on a cylindrical dial; or the like. Alternatively, the manipulation switch 30 may include a touch sensitive panel as the input device. The touch sensitive panel has a pressure sensor, a capacitance sensor or the like in the form of a transmissive plate arranged on a display side of the LCD panel 41.

In the above embodiment, the periphery monitoring apparatus 70 generates the periphery monitoring image 7a by using a video captured by the periphery monitoring camera 71, which is provided to aim an area in back of the vehicle. Alternatively, the vehicle may be equipped with multiple cameras aiming a periphery area around the vehicle. In this case, the periphery monitoring apparatus 70 may combine videos captured by the multiple cameras to generate such a pseudo image that the vehicle is viewed from above the vehicle.

In the above embodiment, GVIF (registered trade mark) system is used as an input/output system for the video signal from the navigation apparatus 50 etc. to the image generation apparatus 100. In addition, in the above embodiment, LVDS system is used as an input/output method for the video signal that is outputted from the control circuit 20 to the LCD device 40. However, the input/output system for the video signal is not limited to those described in the above embodiment. For example, it may be preferable to configure an input/output system of the control-circuit 20 so that the control circuit 20 can receive the main image 2a in the form of data that is outputted according to the output system of the navigation apparatus 50 and the night view apparatus 60 etc. In this case, it is possible to avoid a specification change of the navigation apparatus 50 etc. in respect to an output of the video signal. Further, it may be preferable to configure the control circuit 20 so that the control circuit 20 can output the display image 1 by such an output system that the image data from the control circuit 20 is imputable to the LCD device 40.

In the above embodiment, the LCD device 40 has the number of display pixels of 1280 dots×480 dots. However, the number of display pixels of the LCD device 40 is not limited to the above embodiment. For example, the image generation apparatus may include the LCD device with the number of display pixels larger than 1280 dots×480 dots. Alternatively, the image generation apparatus may include a display device other than the LCD device having the LCD panel. For example, the image generation apparatus may include a display device having a plasma display panel, an organic light emitting display panel, or the like.

In the above embodiment, the navigation apparatus 50, the night view apparatus 60, the periphery monitoring apparatus 70 and the like are described as examples of an apparatus for generating an image. However, the apparatus for generating an image is not limited to the above in-vehicle apparatuses. The image generation apparatus may acquire, as video signals of the main image 2a, video signals of images generated by various apparatuses mounted in the vehicle. Further, the number of pixels of the main image 2a based on the video signal may differ from video signal to video signal. By appropriately changing the number of pixels of the complement image 2b (which is generated by the video drawing portion) in response to the number of pixels of the main image 2a, the image generation apparatus can generate the display image 1 that can efficiently use the main images with different number of pixels.

(Aspects)

According to an aspect of the present disclosure, an image generation apparatus mounted to a vehicle and configured to generate a display image is provided. The image generation apparatus includes a display device, a video acquisition portion, a drawing portion, a combining portion, and an output portion. The display device is provided to face a passenger of the vehicle to display the display image. The video acquisition portion is configured to acquire, from an in-vehicle apparatus mounted to the vehicle, a video signal of a main image that is generated by the in-vehicle apparatus as being smaller in the number of pixels than the display image. The drawing portion is configured to generate a complement image that compensates for a difference in the number of pixels between the display image and the main image. The combining portion is configured to combine the main image, which is based on the video signal acquired by the video acquisition portion, and the complement image, which is generated by the drawing portion. Thereby, the combining portion generates the display image in which the main image and the complement image are placed side by side. The output portion is configured to output a video signal of the display image to the display device to cause the display device to display the display image.

According to the above image generation apparatus, the combining portion can generate the display image having the main image and the complement image arranged side by side, by performing image composition between the main image, which is generated by the in-vehicle apparatus mounted to the vehicle, and the complement image, which is generated by the drawing portion. In this display image, the complement image compensates for a difference in the number of pixels between the display image and the main image. Thus, when the number of pixels of the main image generated by the in-vehicle apparatus is smaller than the number of display pixels of the display device, the image generation apparatus can generate the display image having the number of pixels that matches the number of display pixels of the display device. Because this, when the display device mounted to the vehicle is changed into another one having a larger number of display pixels, the number of pixels of the main image generated by the in-vehicle apparatus needs not to be increased in response to an increase in the number of display pixels of the display device. Therefore, it becomes possible to change the display device into another device having a larger number of display pixels while minimizing a specification change of the in-vehicle apparatus in respect to generation of the main image.

Furthermore, the display image, in which the main image and the complement image are placed side by side, can notify the vehicle passenger of information appearing on the main image 2a together with information appearing on the complement image 2b. Therefore, the display image can efficiently use the number of display pixels of the display device.

In this way, the image generation apparatus can fully use the display performance of the display image while using the main image generated by the existing in-vehicle apparatus.

In the image generation apparatus, the complement image may be smaller in the number of pixels than the main image.

In typical, as the number of pixels of display image is increased, the passenger tends to have a difficulty of finding out high priority information in the display image. Therefore, one may consider that the viewability of the main image 2a for the passenger becomes degraded. However, according to the above image generation apparatus, the display image is displayed on the display device in such way that a display area of the main image is larger than that of the complement image. Therefore, in the display image, the main image 2a can attract the passenger's eyes more than the complement image. Because the main image attracts the passenger's eyes, it is possible to maintain high viewability of the main image for the passenger even when the main image is generated by the existing in-vehicle apparatus and placed next to the complement image in the display image. As can be seen from the above, by keeping the number of pixels of the complement image smaller than that of main image 2a, it is possible to efficiently use the main image 2a generated by the existing in-vehicle apparatus.

In the above image generation apparatus, information notified by the complement image may be different from information notified by the main image.

According to this configuration, since the main image and the complement image can notify different information to the passenger, it is possible to easily increase an amount of information that the display image provides to the driver. Therefore, the image generation apparatus can efficiently use the display performance of the display device having the increased number of display pixels, by generating the display image in which the complement image notifies the passenger of the information different in content than the main image.

In the above image generation apparatus, the in-vehicle apparatus may include a navigation apparatus. The video acquisition portion may acquire a video signal of a navigation image as the video signal of the main image, wherein the navigation image assists operation of the passenger.

In typical, a navigation apparatus generates a navigation image through remarkably-complicated processes. Thus, it is likely that a slight specification change requires a huge amount of work for the specification change. Because of this, when the image generation apparatus makes it possible to use a navigation image generated by an existing navigation apparatus, the amount of work for the specification change caused by an increase in the number of display pixels of the display device can be remarkably reduced. Therefore, the image generation apparatus capable of generating the display image including the navigation image as the main image is suited to efficiently use, while using an existing configuration, the display performance of the display device having the increased number of display pixels.

While the invention has been described above with reference to various embodiments thereof, it is to be understood that the invention is not limited to the above described embodiments and constructions. The invention is intended to cover various modifications and equivalent arrangements.

Further, each or any combination of processes, steps, sections or means explained in the above may be achieved as a software section or means (e.g., subroutine) and/or a hardware section or means (e.g., circuit or integrated circuit), including or not including a function of a related device; furthermore, the hardware section or means can be constructed inside of a microcomputer.

Furthermore, the software section or means or any combinations of multiple software sections or means may be included in a software program, which is contained in a computer-readable storage media or is installed in a computer via a communications network.

What is claimed is:

1. An image generation apparatus mounted to a vehicle and configured to generate a display image, the image generation apparatus comprising:
a display device provided to face a passenger of the vehicle to display the display image;
a video acquisition portion configured to acquire, from an in-vehicle apparatus mounted to the vehicle, a video signal of a main image that is generated by the in-vehicle apparatus as being smaller in the number of pixels than the display image;
a drawing portion configured to generate a complement image that compensates for a difference in the number of pixels between the display image and the main image;
a combining portion configured to generate the display image in which the main image and the complement image are placed side by side, by combining
the main image, which is based on the video signal acquired by the video acquisition portion, and
the complement image, which is generated by the drawing portion; and
an output portion configured to output a video signal of the display image to the display device to cause the display device to display the display image.

2. The image generation apparatus according to claim 1, wherein:
the complement image is smaller in the number of pixels than the main image.

3. The image generation apparatus according to claim 1, wherein:
information notified by the complement image is different from information notified by the main image.

4. The image generation apparatus according to claim 3, wherein:
the in-vehicle apparatus includes a navigation apparatus;
the video acquisition portion acquires a video signal of a navigation image as the video signal of the main image; and
the navigation image assists operation of the passenger.
